(19) United States
(12) Patent Application Publication
(10) Pub. No.: US 2026/0340813 A1
(43) Pub. Date: Oct. 29, 2026

(54) PATTERN INSPECTION APPARATUS AND PATTERN INSPECTION METHOD

(71) Applicant: NuFlare Technology, Inc., Yokohama-shi (JP)

(72) Inventors: Kakeru KARINO, Yokohama-shi (JP); Takafumi INOUE, Chigasaki-shi (JP)

(73) Assignee: NuFlare Technology, Inc., Yokohama-shi (JP)

(21) Appl. No.: 19/709,033

(22) Filed: Jun. 16, 2026

Related U.S. Application Data
(63) Continuation of application No. PCT/JP2025/004418, filed on Feb. 10, 2025.

(30) Foreign Application Priority Data
Mar. 13, 2024 (JP) 2024-039216

(51) Int. Cl. G06T 7/00; G01N 21/956

(52) U.S. Cl. CPC G06T 7/001; G01N 21/95607; G01N 2021/95615; G01N 2021/95676; G06T 2207/30148

(57) ABSTRACT

According to one aspect of the present invention, a pattern inspection apparatus includes: a determination circuit configured to, using gradation values of an optical image and one of a development image and a reference image, determine whether or not contrasts between brightness and darkness of a pattern in the optical image and a pattern in one of the development image and the reference image are reversed; and a comparison circuit configured to compare the optical image with one of (i) a reference image in which a contrast between brightness and darkness is not reversed relative to the optical image and (ii) a reference image based on the development image in which a contrast between brightness and darkness is not reversed relative to the optical image, in a case where it is determined that the contrasts between brightness and darkness are not reversed.

### CROSS-REFERENCE TO RELATED APPLICATION

This application is a continuation application based upon and claims the benefit of priority from prior Japanese Patent Application No. 2024-039216 (application number) filed on Mar. 13, 2024 in Japan, and International Application PCT/JP2025/004418, the International Filing Date of which is Feb. 10, 2025. The contents described in JP2024-039216 and PCT/JP2025/004418 are incorporated herein by reference.

### BACKGROUND OF THE INVENTION

### Field of the Invention

Embodiments described herein relate generally to a pattern inspection apparatus and a pattern inspection method. For example, the embodiments described herein relate generally to an apparatus and a method for inspecting pattern defects of a target object used for semiconductor manufacturing.

### Related Art

Recently, with an increase in the degree of integration and an increase in the capacity of a large-scale integrated circuit (LSI), a circuit line width required for semiconductor elements decreases. These semiconductor elements are manufactured by forming circuits by exposing and transferring a pattern onto a wafer by a reduction projection exposure device called a stepper, using an original pattern (also called a mask or reticle; hereinafter collectively referred to as a mask) on which circuit patterns are formed.

Further, improvement of a yield is indispensable for manufacturing the LSI requiring a large manufacturing cost. However, as represented by a 1-Gbit dynamic random access memory (DRAM), patterns configuring the LSI are on the order of submicron to nanometer. As one of major factors decreasing the yield, there is a pattern defect of a mask used at the time of exposing and transferring an ultrafine pattern on a semiconductor wafer by photolithography technology. In recent years, with the miniaturization of a dimension of an LSI pattern formed on a semiconductor wafer, a dimension to be detected as a pattern defect is also extremely small. For this reason, it is necessary to improve the accuracy of a pattern inspection apparatus for inspecting a defect of a transfer mask used for manufacturing the LSI.

As an inspection method, a method of performing inspection by comparing an optical image obtained by imaging a pattern formed on a target object such as a lithography mask at a predetermined magnification using a magnifying optical system with design data is known. For example, there is a “die to database (die-database) inspection” in which write data (design pattern data) obtained by converting a format of pattern-designed CAD data into an apparatus input format for a writing apparatus to input the pattern-designed CAD data when a pattern is written to a mask is input to an inspection apparatus, a design image (reference image) is generated based on the write data, and the design image is compared with an optical image serving as measurement data obtained by imaging the pattern. In the inspection method in the inspection apparatus, the target object is placed on a stage, and a light flux scans the target object as the stage moves, and the inspection is performed. The target object is irradiated with a light flux by a light source and an illumination optical system. An image of light transmitted through or reflected by the target object is formed on a sensor through the optical system. The image captured by the sensor is sent as measurement data to a comparison circuit. In the comparison circuit, after position adjustment of the images, the measurement data and the reference data are compared according to an appropriate algorithm. When the measurement data and the reference data are not matched, it is determined that there is a pattern defect.

Conventionally, by detecting an alignment mark formed on a mask as a target object and determining whether the alignment mark is a white pattern or a black pattern, whether a main pattern formed on the mask is the white pattern or the black pattern has been determined. However, such a method has a problem that the contrasts between brightness and darkness of the pattern on the design data and the pattern actually formed on the mask may be reversed. If the contrast between brightness and darkness of the pattern is reversed between the design data and the mask, an error is determined in the pattern inspection, which causes a problem.

Here, in order to detect an error portion caused by an inspection apparatus such as reference image corruption in the process of generating a reference image, there is disclosed technology for stopping an inspection in a case where an image having a maximum reaction value between images is continuously, periodically, or discretely generated as a result of comparing a plurality of optical images and a plurality of reference images between corresponding images in actual inspection processing (see, for example, Published Unexamined Japanese Patent Application No. 2018-205184).

### BRIEF SUMMARY OF THE INVENTION

According to one aspect of the present invention, a pattern inspection apparatus includes:
an optical image acquisition mechanism configured to acquire an optical image of a target object to be inspected on which a pattern is formed;
a development image creation circuit configured to create a development image that is developed using design data that is a source of a pattern to be formed in the optical image;
a reference image creation circuit configured to create a reference image obtained by filtering the development image;
a determination circuit configured to, using gradation values of the optical image and one of the development image and the reference image, determine whether or not contrasts between brightness and darkness of a pattern in the optical image and a pattern in the one of the development image and the reference image are reversed; and
a comparison circuit configured to compare the optical image with one of (i) a reference image in which a contrast between brightness and darkness is not reversed relative to the optical image and (ii) a reference image based on the development image in which a contrast between brightness and darkness is not reversed relative to the optical image, in a case where it is determined that the contrasts between brightness and darkness are not reversed.

According to another aspect of the present invention, a pattern inspection method includes:
acquiring an optical image of a target object to be inspected on which a pattern is formed;
creating a development image that is developed using design data that is a source of a pattern to be formed in the optical image;
creating a reference image obtained by filtering the development image;
determining, using gradation values of the optical image and one of the development image and the reference image, whether or not contrasts between brightness and darkness of a pattern in the optical image and a pattern in the one of the development image and the reference image are reversed; and
comparing the optical image with one of (i) a reference image in which a contrast between brightness and darkness is not reversed relative to the optical image and (ii) a reference image based on the development image in which a contrast between brightness and darkness is not reversed relative to the optical image and outputting a comparison result, in a case where it is determined that the contrasts between brightness and darkness are not reversed.

### BRIEF DESCRIPTION OF THE DRAWINGS

FIG. 1 is a configuration diagram illustrating a configuration of a pattern inspection apparatus in a first embodiment;

FIG. 2 is a conceptual diagram for describing an inspection region in the first embodiment;

FIG. 3 is a diagram illustrating an example of an optical image and a development image in the first embodiment;

FIG. 4 is a block diagram illustrating an example of an internal configuration of a contrast determination processing circuit in the first embodiment;

FIG. 5 is a flowchart illustrating an example of main steps of a pattern inspection method in the first embodiment;

FIG. 6 is a diagram illustrating an example of a representative frame in the first embodiment;

FIG. 7 is a diagram illustrating an example of a gradation value of each pixel of a measurement image (optical image) in the first embodiment;

FIG. 8 is a diagram illustrating an example of a gradation value of each pixel of a development image in the first embodiment;

FIG. 9 is a diagram illustrating an example of a line-and-space pattern in the first embodiment;

FIG. 10 is a diagram for describing an example of a determination method in a modification of the first embodiment;

FIG. 11 is a block diagram illustrating an example of an internal configuration of a filter function calculation circuit in the first embodiment;

FIG. 12 is a flowchart illustrating an example of internal steps of a filter function calculation step in the first embodiment;

FIG. 13 is a diagram for describing an example of a relationship among a filter function, a development image, and a measurement image in the first embodiment;

FIG. 14 is a diagram for describing an example of a method for calculating a coefficient of a filter function in the first embodiment;

FIG. 15 is a diagram illustrating an example of figures before and after resizing in the first embodiment;

FIG. 16 is a diagram illustrating an example of figures before and after rounding processing in the first embodiment;

FIG. 17 is a diagram illustrating an example of an internal configuration of a comparison circuit in the first embodiment;

FIG. 18 is a block diagram illustrating an example of an internal configuration of a contrast determination processing circuit in a second embodiment; and

FIG. 19 is a flowchart illustrating an example of main steps of a pattern inspection method in the second embodiment.

### DETAILED DESCRIPTION OF THE INVENTION

Hereinafter, embodiments provide an inspection apparatus and an inspection method capable of determining whether or not a contrast between brightness and darkness of a pattern is reversed between design data and a target object.

### First Embodiment

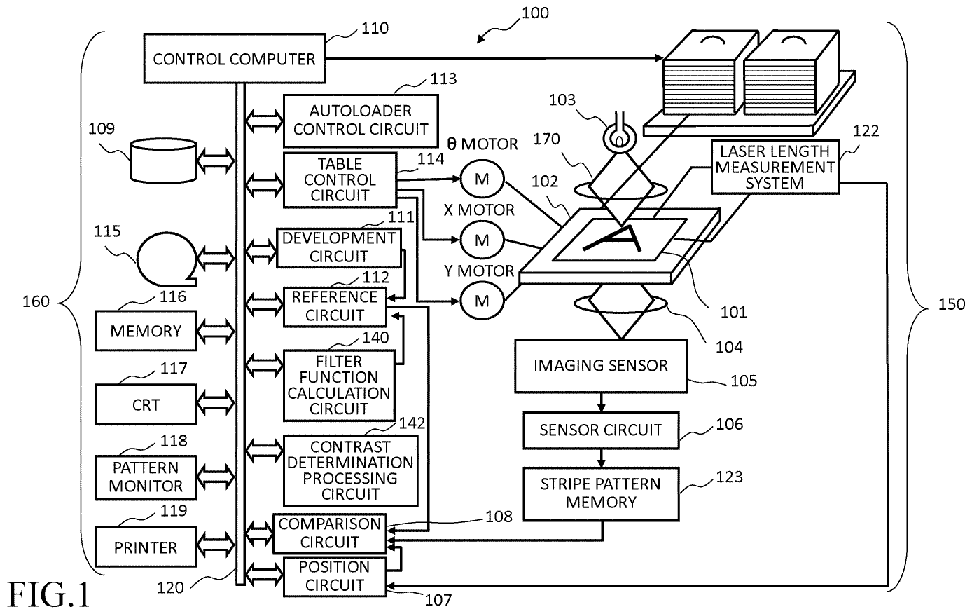

FIG. 1 is a configuration diagram illustrating a configuration of a pattern inspection apparatus in a first embodiment. In FIG. 1, an inspection apparatus 100 that inspects a defect of a pattern formed on a target object, for example, a mask includes an optical image acquisition mechanism 150 and a control system circuit 160 (control unit).

The optical image acquisition mechanism 150 includes a light source 103, an illumination optical system 170, an XYθ table 102 to be movably arranged, a magnifying optical system 104, an imaging sensor 105 (an example of a sensor), a sensor circuit 106, a stripe pattern memory 123, and a laser length measurement system 122.

A target object 101 is disposed on the XYθ table 102. Examples of the target object 101 include a photomask for exposure for transferring a pattern to a wafer.

A pattern including a plurality of figures to be inspected is formed in the photomask. The target object 101 is disposed on the XYθ table 102 with a pattern formation surface disposed downward, for example.

A line sensor or a two-dimensional sensor is used as the imaging sensor 105. For example, a time delay integration (TDI) sensor is preferably used. The TDI sensor has a plurality of photosensor elements arranged two-dimensionally. When each photosensor element captures an image, a predetermined image accumulation time is set. In the TDI sensor, outputs of a plurality of photosensor elements arranged in a scanning direction are integrated and output. The plurality of photosensor elements arranged in the scanning direction image the same pixel while shifting the time according to the movement of the XYθ table 102. When a line sensor is used, a plurality of photosensor elements are arranged in a direction orthogonal to the scanning direction.

In the control system circuit 160, a control computer 110 that is a computer is connected to a position circuit 107, a comparison circuit 108, a development circuit 111, a reference circuit 112, an autoloader control circuit 113, a table control circuit 114, a filter function calculation circuit 140, a contrast determination processing circuit 142, a magnetic disk drive 109, a memory 116, a flexible disk device (FD) 115, a CRT 117, a pattern monitor 118, and a printer 119 via a bus 120. The sensor circuit 106 is connected to the stripe pattern memory 123, and the stripe pattern memory 123 is connected to the comparison circuit 108. The XYθ table 102 is driven by an X-axis motor, a Y-axis motor, and a θ-axis motor. The XYθ table 102 is an example of a stage.

Note that a series of “circuits” such as the position circuit 107, the comparison circuit 108, the development circuit 111, the reference circuit 112, the autoloader control circuit 113, the table control circuit 114, the filter function calculation circuit 140, and the contrast determination processing circuit 142 includes a processing circuit. The processing circuit includes an electric circuit, a computer, a processor, a circuit board, a quantum circuit, or a semiconductor device. Each circuit may be configured using the same processing circuit (one processing circuit), or different processing circuits (separate processing circuits) may be used. For example, a series of “circuits” such as the position circuit 107, the comparison circuit 108, the development circuit 111, the reference circuit 112, the autoloader control circuit 113, the table control circuit 114, the filter function calculation circuit 140, and the contrast determination processing circuit 142 may be configured by the control computer 110 and executed. Input data necessary for the position circuit 107, the comparison circuit 108, the development circuit 111, the reference circuit 112, the autoloader control circuit 113, the table control circuit 114, the filter function calculation circuit 140, and the contrast determination processing circuit 142 or a calculated result is stored in a memory (not illustrated) in each circuit or a memory 115 each time. Input data necessary for the control computer 110 or a calculation result is stored in a memory (not illustrated) in the control computer 110 or the memory 115 each time. A program for executing a processor or the like may be recorded on a record carrier body such as the magnetic disk drive 109, the FD 116, or a read only memory (ROM).

In the inspection apparatus 100, a high-magnification inspection optical system is configured by the light source 103, the XYθ table 102, the illumination optical system 170, the magnifying optical system 104, the imaging sensor 105, and the sensor circuit 106. The XYθ table 102 is driven by the table control circuit 114 under the control of the control computer 110. The XYθ table 102 is movable by a drive system such as a three-axis (X-Y-θ) motor that is driven in an X direction, a Y direction, and a θ direction. For the X-axis motor, Y-axis motor, and θ-axis motor, for example, step motors can be used. The XYθ table 102 is movable in a horizontal direction and a rotational direction by the motors of the X, Y, and θ axes. In addition, a movement position of the target object 101 arranged on the XYθ table 102 is measured by the laser length measurement system 122 and supplied to the position circuit 107.

Write data (design data) to be a basis of pattern formation of the inspected target object 101 is input from the outside of the inspection apparatus 100 and stored in the magnetic disk drive 109. A plurality of figures are defined in the write data, and each figure is normally configured by a combination of a plurality of element figures. There may be a figure including one figure. On the target object 101, each corresponding pattern is formed based on each figure defined in the write data.

Here, in FIG. 1, the configurations necessary for describing the first embodiment are described. It goes without saying that the inspection apparatus 100 may normally include other necessary configurations.

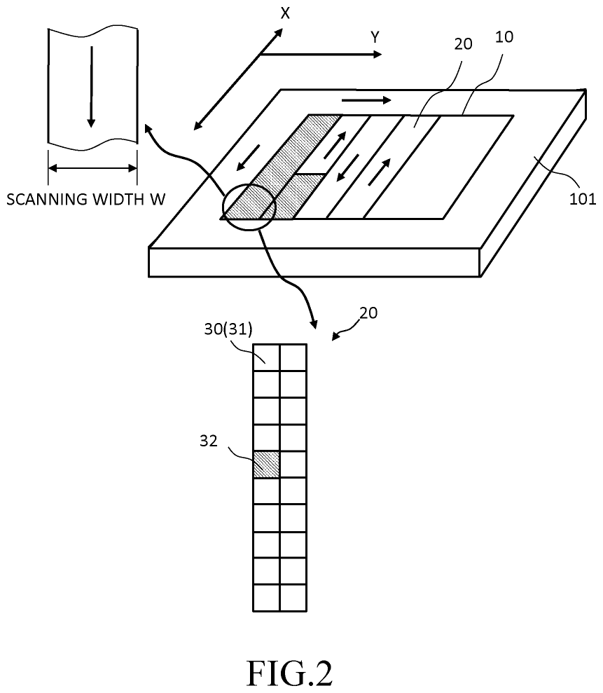

FIG. 2 is a conceptual diagram for describing an inspection region in the first embodiment. As illustrated in FIG. 2, an inspection region 10 (the entire inspection region) of the target object 101 is virtually divided into a plurality of strip-shaped inspection stripes 20 having a scanning width W of the imaging sensor 105, for example, in the Y direction. In addition, the inspection apparatus 100 acquires an image (stripe region image) for each inspection stripe 20. For each of the inspection stripes 20, an image of a figure arranged in the inspection stripe 20 is captured in a longitudinal direction (X direction) of the stripe region using laser light (inspection light). In order to prevent missing of an image, the plurality of inspection stripes 20 are preferably set such that adjacent inspection stripes 20 overlap each other with a predetermined margin width.

The optical image is acquired while the imaging sensor 105 continuously moves relatively in the X direction by the movement of the XYθ table 102. The imaging sensor 105 continuously captures an optical image having the scanning width W as illustrated in FIG. 2. In the first embodiment, after the imaging sensor captures an optical image in one inspection stripe 20, the imaging sensor moves to a position of the next inspection stripe 20 in the Y direction and then continuously captures an optical image having the scanning width W similarly while moving in an opposite direction. That is, imaging is repeated in a forward (FWD)-backward (BWD) direction in which a forward path and a backward path are in opposite directions.

In actual inspection, as illustrated in FIG. 2, a stripe region image of each inspection stripe 20 is divided into images (frame images 31) of a plurality of rectangular frame regions 30. In addition, the inspection is performed for each frame image 31 of the frame region 30. For example, the image is divided into a size of 512×512 pixels. Therefore, a reference image to be compared with the frame image 31 of the frame region 30 is similarly created for each frame region 30.

Here, the imaging direction is not limited to repetition of forward (FWD)-backward (BWD). Imaging may be performed from one direction. For example, the imaging direction may be repetition of FWD-FWD. Alternatively, the imaging direction may be repetition of BWD-BWD.

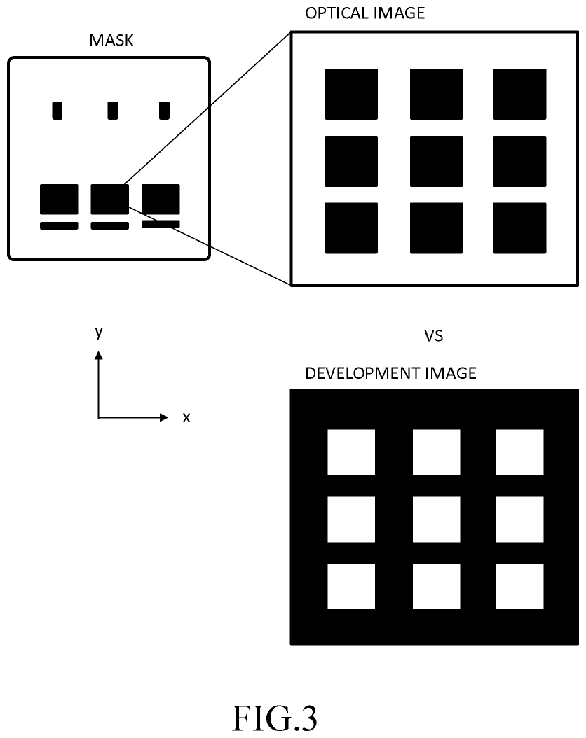

FIG. 3 is a diagram illustrating an example of an optical image and a development image in the first embodiment. In the example of FIG. 3, an example of a frame image (optical image) of a frame region having a pattern region formed in a mask to be the target object 101 and an example of a development image obtained by developing an image of design data that is a basis of the frame image are illustrated. As illustrated in FIG. 3, a contrast between brightness and darkness of a pattern to be formed is reversed between the frame image (optical image) and the development image. Even if a reference image is created from the development image and the reference image and the frame image are compared in this state, the comparison results in a comparison between the white pattern and the black pattern in units of pixels. Therefore, for example, a gradation difference becomes larger than a determination threshold, and a defect is determined. However, such a portion is not a defect of the pattern itself but a result of mistaking the comparison partner. Therefore, in the first embodiment, it is determined whether or not the contrast between brightness and darkness of the pattern of the image created from the design data is matched with the contrast between brightness and darkness of the pattern of the image actually measured from the target object 101.

Here, the pixel data of the optical image captured from the target object 101 is in a state in which a filter acts due to resolution characteristics of an optical system used for imaging or the like, in other words, in an analog state that continuously changes. For this reason, the image intensity (gray value) is different from that of a development image described later having a digital value.

Therefore, filter processing is performed on the development image to create a reference image close to the measurement data, and the reference image and the measurement image (optical image) are compared.

Therefore, before inspection processing on the target object 101 is performed, first, a filter function for performing the filter processing is calculated. At that time, if the contrasts between brightness and darkness of the patterns are reversed between the image created from the design data described above and the image actually measured from the target object 101, it is difficult to obtain a highly accurate filter function. Therefore, in the first embodiment, before the processing of calculating the filter function, it is determined whether or not the contrasts between brightness and darkness of the patterns are matched.

In the embodiment, “the contrast between brightness and darkness of the pattern is not reversed” or “the contrasts between brightness and darkness of the patterns are matched” does not indicate complete matching of gradation values, but indicates that there is no reversal between the pattern on the white pattern side and the pattern on the black pattern side. In a case where an upper limit value and a lower limit value of a detection level of the inspection apparatus 100 are set, a level exceeding an intermediate value between the upper limit value and the lower limit value belongs to the white pattern side, and a level less than the intermediate value belongs to the black pattern side. For example, in a case where the detection level is set to gradation values 20 to 240, a level having a gradation value exceeding an intermediate value, for example, 130 belongs to the white pattern side, and a level having a gradation value of less than 130 belongs to the black pattern side. Alternatively, for example, in a case where the gradation value of the pixel is defined with 256 gradations, a level having a gradation value exceeding an intermediate value, for example, 128 belongs to the white pattern side, and a level having a gradation value of less than 128 belongs to the black pattern side.

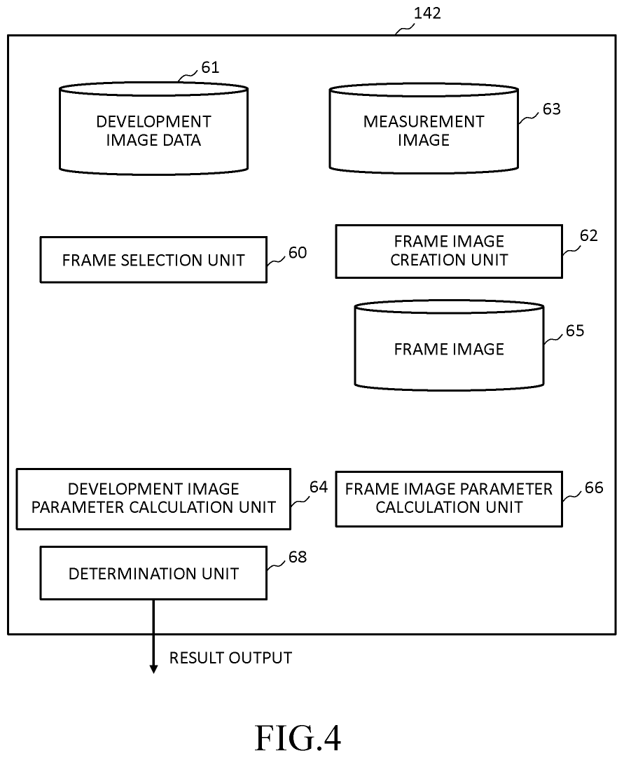

FIG. 4 is a block diagram illustrating an example of an internal configuration of a contrast determination processing circuit in the first embodiment. In FIG. 4, storage devices 61, 63, and 65 such as magnetic disks, a frame selection unit 60, a frame image creation unit 62, a development image parameter calculation unit 64, a frame image parameter calculation unit 66, and a determination unit 68 are arranged in the contrast determination processing circuit 142.

A series of “units” such as the frame selection unit 60, the frame image creation unit 62, the development image parameter calculation unit 64, the frame image parameter calculation unit 66, and the determination unit 68 includes a processing circuit. The processing circuit includes an electric circuit, a computer, a processor, a circuit board, a quantum circuit, or a semiconductor device. Further, a common processing circuit (same processing circuit) may be used for each “unit”. Alternatively, a different processing circuit (separate processing circuit) may be used. Input data necessary for the frame selection unit 60, the frame image creation unit 62, the development image parameter calculation unit 64, the frame image parameter calculation unit 66, and the determination unit 68 or a calculated result is stored in a memory (not illustrated) in the contrast determination processing circuit 142 or the memory 115 each time.

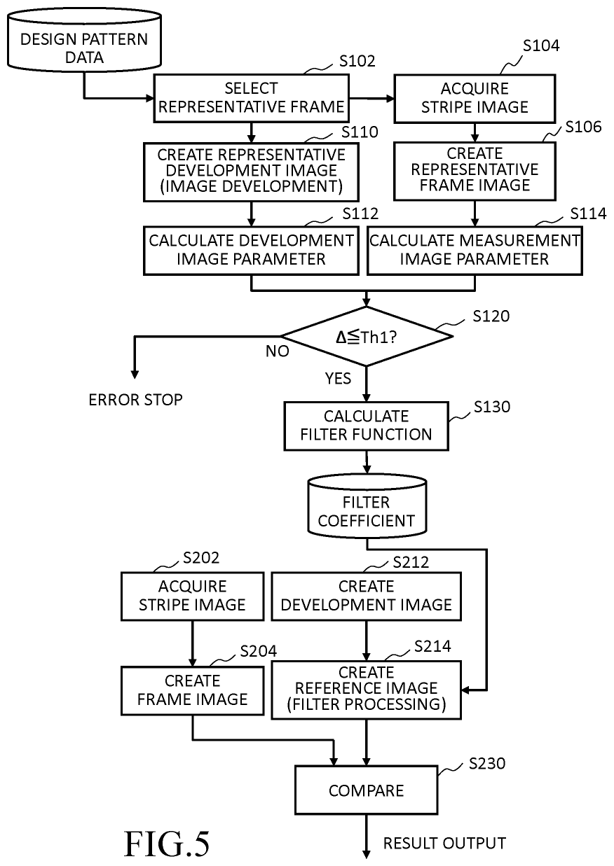

FIG. 5 is a flowchart illustrating an example of main steps of a pattern inspection method in the first embodiment. In FIG. 5, the pattern inspection method according to the first embodiment performs a series of steps including a representative frame selection step (S102), a stripe image acquisition step (S104), a representative frame image creation step (S106), a representative development image creation step (S110), a development image parameter calculation step (S112), a measurement image parameter calculation step (S114), a determination step (S120), a filter function calculation step (S130), a stripe image acquisition step (S202), a frame image creation step (S204), a development image creation step (S212), a reference image creation step (S214), and a comparison step (S230). S120 to S214 in FIG. 5 correspond to “inspection setup processing (inspection setup start to inspection setup continuation (to inspection setup end))”.

As the representative frame selection step (S102), the frame selection unit 60 selects a representative frame from the inspection region 10. As illustrated in FIG. 2, the stripe region of each inspection stripe 20 is divided into, for example, a plurality of frame regions 30, and the inspection is performed for each frame region 30. In other words, the inspection region 10 of the target object 101 is virtually divided into a plurality of frame regions 30, and the inspection is performed for each frame region 30. Here, a frame region (representative frame) used to determine the contrast between brightness and darkness of the pattern is selected from the inspection region 10 of the target object 101.

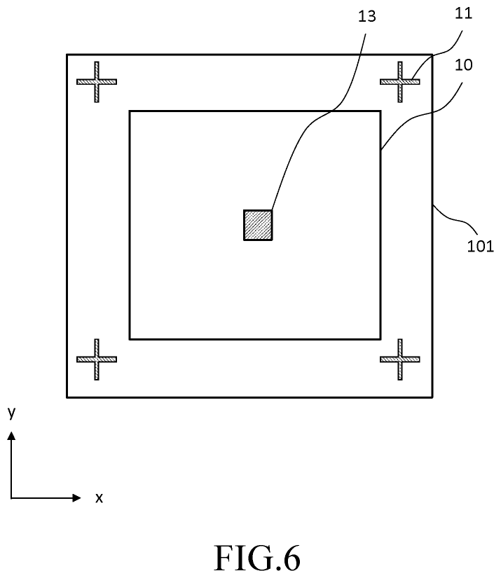

FIG. 6 is a diagram illustrating an example of a representative frame in the first embodiment. In the example of FIG. 6, in the target object 101, a plurality of alignment marks 11 are formed around the inspection region 10 where the pattern is formed. The representative frame 13 is selected from the inspection region 10. For example, it is preferable to select a central portion of the inspection region 10 as the representative frame 13. However, the present disclosure is not limited thereto. Other positions may be used.

As the stripe image acquisition step (S104), the optical image acquisition mechanism 150 acquires an optical image of the inspection stripe 20 including the representative frame 13 of the target object 101. Specifically, the following operation is performed.

First, the XYθ table 102 is moved to a position where the inspection stripe 20 including the representative frame 13 can be imaged. The pattern formed on the target object 101 is irradiated with laser light (for example, DUV light) having a wavelength in the ultraviolet region or less to be inspection light from an appropriate light source 103 through the illumination optical system 170. The light transmitted through the target object 101 forms an image as an optical image on the imaging sensor 105 (an example of a sensor) through the magnifying optical system 104, and enters the imaging sensor 105.

An image of the pattern formed on the imaging sensor 105 is photoelectrically converted by each light receiving element of the imaging sensor 105, and further subjected to analog/digital (A/D) conversion by the sensor circuit 106. In addition, pixel data of the inspection stripe 20 to be measured is stored in the stripe pattern memory 123. Thereafter, the stripe region image is sent to the contrast determination processing circuit 142 together with the data indicating the position of the target object 101 on the XYθ table 102 output from the position circuit 107. The measurement data (pixel data) is, for example, 8-bit unsigned data, and expresses the gradation (light amount) of the brightness of each pixel. The stripe region image output into the contrast determination processing circuit 142 is stored in the storage device 63.

As the representative frame image creation step (S106), the frame image creation unit 62 creates a frame image (representative frame image) of the representative frame 13. Specifically, the stripe region image is divided in a predetermined size in the x direction so that the frame image (representative frame image) of the representative frame 13 is cut out from the stripe region image (optical image) of the inspection stripe 20 including the representative frame 13. For example, the stripe region image is divided into frame images of 512×512 pixels. The data of the divided representative frame image is output to and stored in the storage device 65.

As the representative development image creation step (S110), the development circuit 111 (an example of a development image creation unit) creates a development image (representative development image) by developing an image based on design pattern data that is a basis of pattern formation of the target object 101 to be inspected. Specifically, the design data is read from the magnetic disk drive 109 through the control computer 110, and each figure of the region of the representative frame 13 defined in the read design data is converted (image development) into binary or multi-valued image data to create a development image (representative development image).

Here, in the figure defined in the design pattern data, for example, a rectangle or a triangle is used as a basic figure. For example, figure data (vector data) in which a form, a size, a position, and the like of each pattern figure are defined by information such as the coordinates (x, y) at a reference position of the figure, a length of a side, and a figure code to be an identifier to distinguish a figure type such as the rectangle or the triangle is stored.

If information of the design pattern to be the figure data is input to the development circuit 111, the data is expanded into data of each figure and a figure code illustrating the figure shape of the figure data, a figure dimension, and the like are interpreted. In addition, the data is expanded into binary or multi-valued design image data as a pattern disposed in a square with a grid of a predetermined quantization dimension as a unit and is output. In other words, the design data is read, an occupancy rate occupied by the figure in the design pattern is calculated for each square formed by virtually dividing the inspection region as a square with a predetermined dimension as a unit, and n-bit occupancy rate data is output. For example, it is preferable to set one square as one pixel. Assuming that one pixel has a resolution of ½⁸ (= 1/256), a small region of 1/256 is allocated by the region of the figure disposed in the pixel to calculate the occupancy rate in the pixel. Then, a development image of 8-bit occupancy rate data is created for each pixel. Data of the development image is output to the contrast determination processing circuit 142 and stored in the storage device 61.

As the development image parameter calculation step (S112), the development image parameter calculation unit 64 reads the data of the development image stored in the storage device 61, and calculates a parameter for determining the contrast between brightness and darkness of the pattern. For example, it is preferable to calculate an average gradation value of all pixels in the development image of the representative frame 13 as the parameter.

As the measurement image parameter calculation step (S114), the frame image parameter calculation unit 66 reads the data of the frame image stored in the storage device 65 and calculates a parameter for determining the contrast between brightness and darkness of the pattern. As the parameter, for example, it is preferable to calculate an average gradation value of all pixels in the frame image (an example of the measurement image and the optical image) of the representative frame 13.

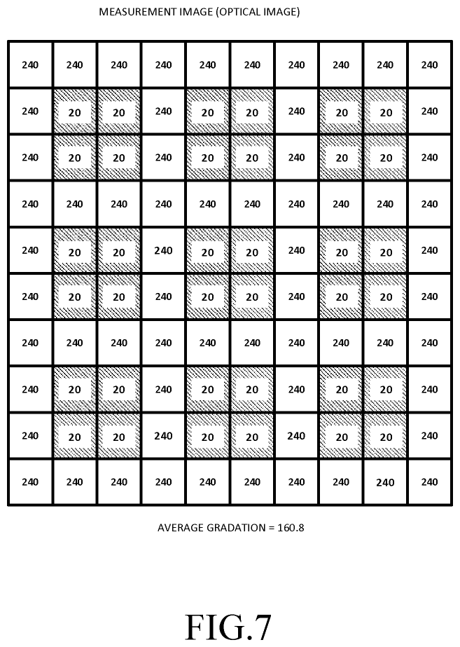

FIG. 7 is a diagram illustrating an example of a gradation value of each pixel of the measurement image (optical image) in the first embodiment;

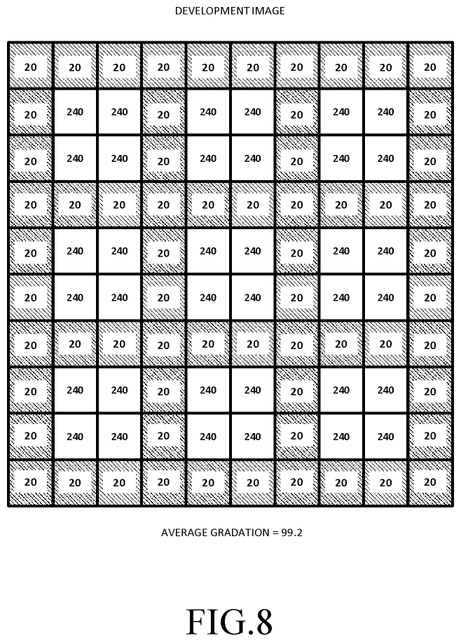

FIG. 8 is a diagram illustrating an example of a gradation value of each pixel of the development image in the first embodiment.

In the example of FIG. 7, an example of the gradation value of each pixel of the optical image illustrated in FIG. 3 is illustrated. In the example of FIG. 8, an example of the gradation value of each pixel of the development image illustrated in FIG. 3 is illustrated. The images illustrated in the examples of FIGS. 7 and 8 include, for example, 10×10 pixels, and each pixel is defined by 256 gradations. Further, a gradation value of a white pattern is indicated by, for example, 240, and a gradation value of a black pattern is indicated by, for example, 20. In the measurement image of FIG. 7, the average gradation value is 160.8, whereas in the development image of FIG. 8, the average gradation value is 99.2.

As the determination step (S120), the determination unit 68 uses the gradation values of the optical image and the development image to determine whether or not the contrasts between brightness and darkness of the pattern in the optical image and the pattern in the development image are reversed. Here, the determination unit 68 compares the average gradation value of the entire image of the optical image with the average gradation value of the entire image of the development image to determine whether or not the contrasts between brightness and darkness of the patterns of both images are reversed. Specifically, it is determined whether or not a difference Δ between the average gradation value of the entire image of the optical image and the average gradation value of the entire image of the development image is within a range of a threshold Th1. When the difference Δ is within the range of the threshold Th1, it is determined that the contrasts between brightness and darkness of the pattern in the optical image and the pattern in the development image are not reversed. When the difference Δ exceeds the range of the threshold Th1, it is determined that the contrasts between brightness and darkness of the pattern in the optical image and the pattern in the development image are reversed. In the examples of FIGS. 7 and 8, a difference Δ obtained by subtracting the average gradation value of the entire image of the development image from the average gradation value of the entire image of the optical image is 61.6 (=160.8-99.2). The threshold Th1 is, for example, +20. Therefore, in the examples of FIGS. 7 and 8, since the difference Δ exceeds the range of the threshold Th1, the determination unit 68 determines that the contrasts between brightness and darkness of the patterns of both images are reversed.

In the example described above, a case where it is determined whether or not the contrasts between brightness and darkness of the patterns are reversed by comparing the average gradation value of the entire image of the optical image with the average gradation value of the entire image of the development image has been illustrated, but the present disclosure is not limited thereto.

For example, the determination unit 68 may be configured to determine whether or not the contrasts between brightness and darkness are matched for each pixel. Specifically, a difference between gradation values is calculated for each pixel, and it is determined whether or not the difference Δ is within the range of the threshold Th1. The determination may be performed for all the pixels in the image, or the determination may be performed for several pixels to several tens of pixels for an image including a plurality of pixels in a part of the image, for example, a total of 100 pixels of 10×10 pixels. Alternatively, in a case where the result that the contrasts between brightness and darkness are reversed is continuously out of the range of the threshold Th1 for several pixels to several tens of pixels, it is also preferable to determine that the contrasts between brightness and darkness of the patterns of both images are reversed.

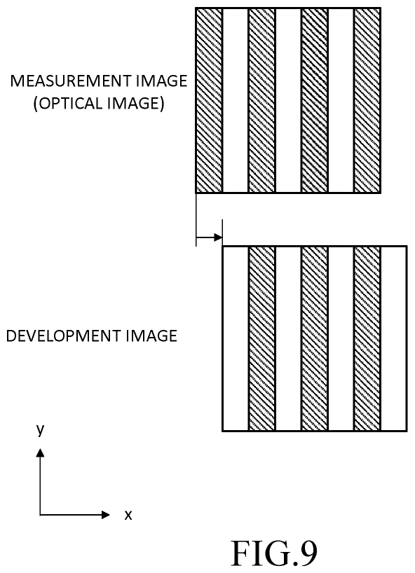

FIG. 9 is a diagram illustrating an example of a line-and-space pattern in the first embodiment. For example, in a line-and-space pattern of 1:1, the average gradation values of the development image and the frame image (measurement image) are matched with each other although the contrasts between brightness and darkness are originally reversed. Therefore, it is determined that the contrasts between brightness and darkness are not reversed. Further, even in a case of comparing whether or not the contrasts between brightness and darkness are reversed for each pixel, as illustrated in FIG. 9, if the development image and the frame image (measurement image) overlap at a position shifted by ½ pitch of the line-and-space pattern, the contrasts between brightness and darkness are matched, and the determination may be wrong.

Therefore, it is also preferable that the determination unit 68 determines whether or not the contrasts between brightness and darkness of the patterns are reversed by comparing, for each pixel, whether or not signs of gradients of gradation values are matched between a target pixel and an adjacent pixel adjacent to the target pixel.

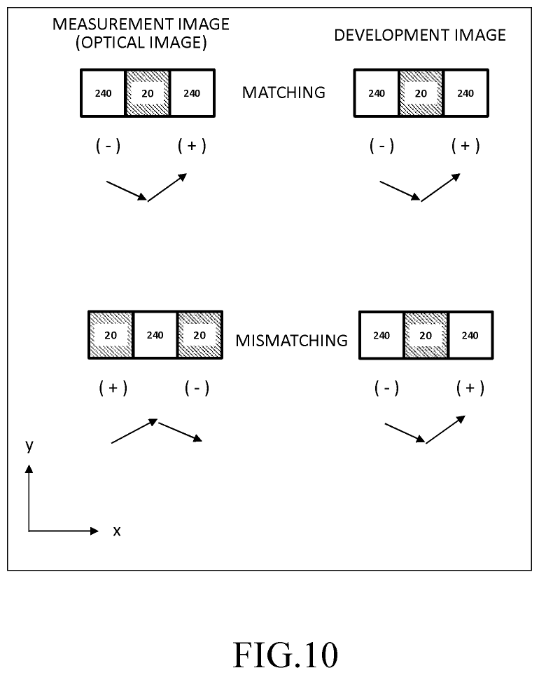

FIG. 10 is a diagram for describing an example of a determination method in a modification of the first embodiment. In the modification, the determination unit 68 calculates the gradient of the gradation value from the determination target pixel to the adjacent pixel. As illustrated in FIG. 10, in a case where the gradation value of the determination target pixel of the frame image (measurement image) is, for example, 20, if the gradation value of the adjacent pixel adjacent in the +x direction is, for example, 240, the sign is calculated as positive (+). Similarly, in a case where the gradation value of the determination target pixel of the development image is, for example, 20, if the gradation value of the adjacent pixel adjacent in the +x direction is, for example, 240, the sign is calculated as positive (+). Therefore, if both the images have positive signs, it can be predicted that the contrasts between brightness and darkness are not reversed. Actually, in a case where not only one pixel but also several pixels to several tens of pixels have the same sign between both the images, it can be determined that the contrasts between brightness and darkness are not reversed. The determination may be performed based on a sign between the determination target pixel and the adjacent pixel adjacent in the −x direction. In addition, the sign may be calculated between pixels adjacent in the y direction instead of the x direction. In the example of FIG. 10, in a case where both the sign of the target pixel with the adjacent pixel in the +x direction and the sign of the target pixel with the adjacent pixel in the −x direction are matched between the measurement image and the development image, it can be determined that the contrasts between brightness and darkness are not reversed. On the other hand, in a case where both the sign of the target pixel with the adjacent pixel in the +x direction and the sign of the target pixel with the adjacent pixel in the −x direction are not matched between the measurement image and the development image, it can be determined that the contrasts between brightness and darkness are reversed. Even in such a case, comparison may be similarly performed in a plurality of pixels.

In such a method, since the signs are determined between the pixels in the image, it is possible to eliminate an influence of the deviation of the overlapping position between the development image and the frame image (measurement image). In addition, with such a method, it is possible to determine whether or not the contrasts between brightness and darkness of the patterns are reversed even in the line-and-space pattern of 1:1.

In a case where the contrasts between brightness and darkness of the pattern in the measurement image (optical image) and the pattern in the development image are not reversed, the process proceeds to the filter function calculation step (S130). In a case where the contrasts between brightness and darkness of the pattern in the measurement image and the pattern in the development image are reversed, an error is output. Therefore, the filter function calculation step (S130) is not performed, and the process ends as an error. In such a case, the design pattern data itself is converted into monochrome reversed data (tone reversed), and then the process is performed again from the beginning.

As the filter function calculation step (S130), the filter function calculation circuit 140 calculates a filter function for creating a reference image. The details will be described below.

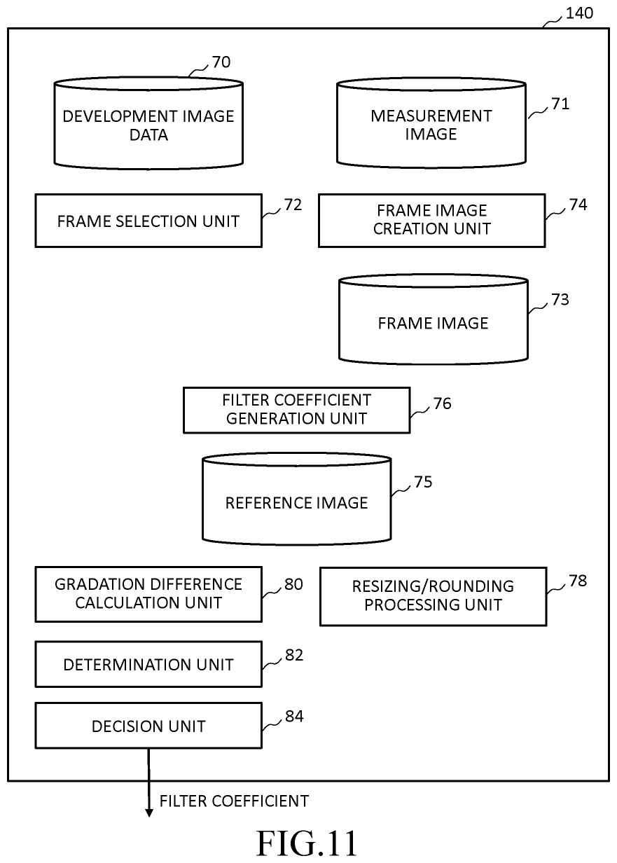

FIG. 11 is a block diagram illustrating an example of an internal configuration of a filter function calculation circuit in the first embodiment. In FIG. 11, in the filter function calculation circuit 140, storage devices 70, 71, 73, and 75 such as magnetic disks, a frame selection unit 72, a frame image creation unit 74, a filter coefficient generation unit 76, a resizing/rounding processing unit 78, a gradation difference calculation unit 80, a determination unit 82, and a decision unit 84 are arranged.

A series of “units” such as the frame selection unit 72, the frame image creation unit 74, the filter coefficient generation unit 76, the resizing/rounding processing unit 78, the gradation difference calculation unit 80, the determination unit 82, and the decision unit 84 includes a processing circuit. The processing circuit includes an electric circuit, a computer, a processor, a circuit board, a quantum circuit, or a semiconductor device. Further, a common processing circuit (same processing circuit) may be used for each “unit”. Alternatively, a different processing circuit (separate processing circuit) may be used. Input data necessary for the frame selection unit 72, the frame image creation unit 74, the filter coefficient generation unit 76, the resizing/rounding processing unit 78, the gradation difference calculation unit 80, the determination unit 82, and the decision unit 84 or a calculated result is stored in a memory (not illustrated) in the filter function calculation circuit 140 or the memory 115 each time.

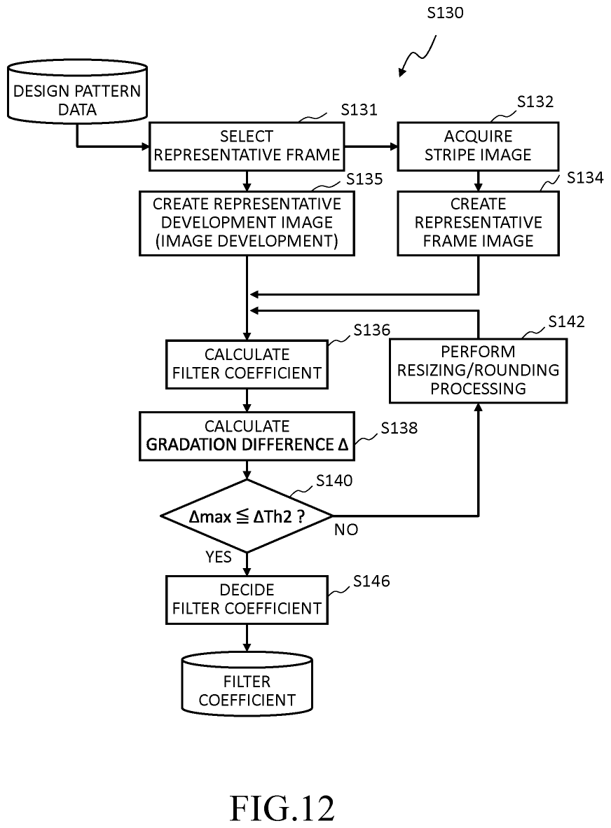

FIG. 12 is a flowchart illustrating an example of internal steps of the filter function calculation step in the first embodiment. In FIG. 12, the filter function calculation step (S130) performs a series of steps including a representative frame selection step (S131), a stripe image acquisition step (S132), a representative frame image creation step (S134), a representative development image creation step (S135), a filter coefficient calculation step (S136), a gradation difference calculation step (S138), a determination step (S140), a resizing/rounding processing step (S142), and a filter coefficient decision step (S146) as internal steps thereof.

As the representative frame selection step (S131), the frame selection unit 72 selects a representative frame to be used for obtaining the filter function in the inspection of the target object 101. As illustrated in FIG. 2, each inspection stripe 20 is divided into, for example, a plurality of frame regions 30, and inspection is performed for each frame region 30. In other words, the inspection region 10 of the target object 101 is virtually divided into a plurality of frame regions 30, and the inspection is performed for each frame region 30. Here, a frame region (representative frame) used to generate the filter function is selected from the inspection region 10 of the target object 101. The position of the frame region (representative frame) to be selected may be arbitrarily set in advance by a user. Alternatively, a predetermined selection condition may be set, and the position of the frame region may be selected according to the selection condition.

As the stripe image acquisition step (S132), the optical image acquisition mechanism 150 acquires an optical image of the inspection stripe 20 including the representative frame 13 of the target object 101. The contents of the stripe image acquisition step (S132) are similar to those of the stripe image acquisition step (S104) except that a frame region to be selected may be different. The stripe region image is sent to the filter function calculation circuit 140 together with the data indicating the position of the target object 101 on the XYθ table 102 output from the position circuit 107. The measurement data (pixel data) is, for example, 8-bit unsigned data, and expresses the gradation (light amount) of the brightness of each pixel. The stripe region image output into the filter function calculation circuit 140 is stored in the storage device 71.

As the representative frame image creation step (S134), the frame image creation unit 74 creates a frame image (representative frame image) of the representative frame. Specifically, the stripe region image is divided into a predetermined size in the x direction so that the frame image (representative frame image) of the representative frame is cut out from the stripe region image (optical image) of the inspection stripe 20 including the representative frame. For example, the stripe region image is divided into frame images of 512×512 pixels. The data of the divided representative frame image is output to and stored in the storage device 73.

As the representative development image creation step (S135), the development circuit 111 (an example of a development image creation unit) creates a development image (representative development image) by developing an image based on design pattern data that is a basis of pattern formation of the target object 101 to be inspected. The contents of the representative development image creation step (S135) are similar to those of the representative development image creation step (S110). The created development image data is sent to the filter function calculation circuit 140. The development image output into the filter function calculation circuit 140 is stored in the storage device 70.

As the filter coefficient calculation step (S136), the filter coefficient generation unit 76 calculates a coefficient of a filter function for creating a reference image.

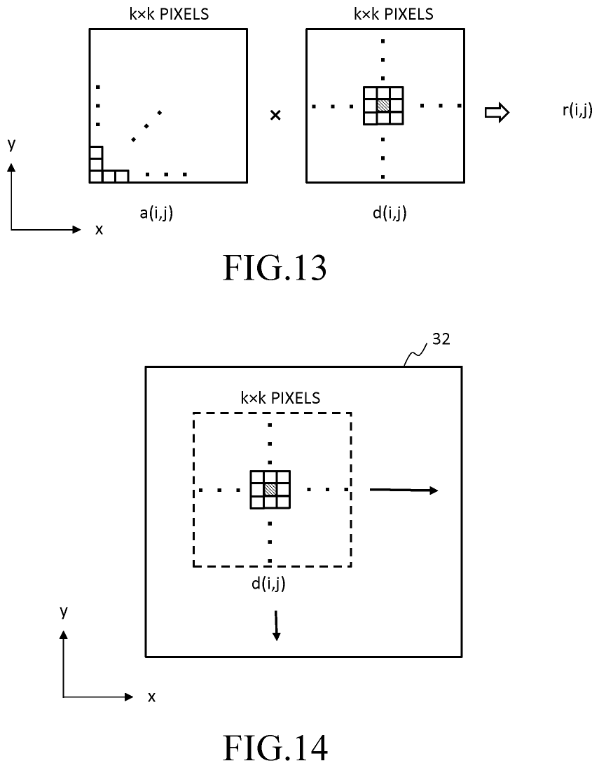

FIG. 13 is a diagram for describing an example of a relationship among a filter function, a development image, and a measurement image in the first embodiment.

FIG. 14 is a diagram for describing an example of a method for calculating a coefficient of a filter function in the first embodiment. For example, as illustrated in FIG. 13, an unknown coefficient matrix a(i, j) (an example of a filter function) including k×k elements smaller than the number of pixels of the frame region is obtained by the following method. For example, for an image of a frame region including 512×512 pixels, for example, a coefficient matrix a(i, j) of 15×15 is obtained. A coefficient matrix a(i, j) (i, j) in which a value obtained by dividing the sum of products of the k×k pixels and the coefficient matrix a(i, j) by the number of pixels N(=k×k) approaches a target pixel r(i, i) of a frame image of a representative frame corresponding to a target pixel d(i, i) of the development image with the target pixel d(i, i) as the center is obtained. Such a relational expression (1) is shown below.

$$\frac{{\sum }_{i , j = - k / 2}^{k / 2} a ( i , j ) \cdot d ( i , j )}{N} = r ( i , j ) \qquad ( 1 )$$

As illustrated in FIG. 14, the relational expression (1) is calculated each time the target pixel is moved within the representative frame. Then, the coefficient matrix a(i, j) that most satisfies the relational expression (1) defined using the unknown coefficient matrix a(i, j) obtained for all pixels in the representative frame is obtained. The number of elements k×k of the coefficient matrix a(i, j) may be appropriately set. If the number of elements is small, accuracy is deteriorated, and if the number of elements is too large, calculation time becomes long. In addition, when the target pixel moves in the representative frame, if the target pixel is close to the end portion, there may be a case where pixels around the end portion side do not exist as much as necessary. In such a case, calculation may be performed using surrounding pixels and the number of pixels N from which a value is obtained.

As described above, the coefficient matrix a(i, j) of the filter function is obtained. The coefficient matrix a (i, j) is a candidate for a filter function for creating a reference image.

As the gradation difference calculation step (S138), first, the reference circuit 112 creates a candidate for the reference image using the candidate for the generated filter function. Specifically, the following operation is performed. The reference circuit 112 creates a candidate for the reference image corresponding to the frame image (measurement image) of the representative frame using the candidate for the filter function. First, the reference circuit 112 creates, for each pixel, reference image data obtained by dividing a sum of products of k×k pixels and a coefficient matrix a(i, j) serving as a filter function by the number of pixels N(=k×k) with the pixel d(i, i) as a center, for a pattern in the development image of the representative frame. The obtained reference image data is transmitted to the filter function calculation circuit 140 and stored in the storage device 75.

Next, the gradation difference calculation unit 80 calculates a gradation difference Δ by subtracting the pixel value of the measurement image from the pixel value of the created reference image. Such a gradation difference is calculated for each pixel in the image.

As the determination step (S140), the determination unit 82 uses the maximum gradation difference Δmax between the candidate for the reference image and the frame image (optical image) of the representative frame to determine whether or not there is a candidate for the reference image in which the maximum gradation difference Δmax is equal to or less than the threshold ΔTh2. The maximum gradation difference Δmax indicates a maximum value among a plurality of gradation differences obtained in all pixels in the image.

When the maximum gradation difference Δmax is not equal to or less than the threshold ΔTh2, the process proceeds to the resizing/rounding processing step (S142). When the maximum gradation difference Δmax is equal to or less than the threshold ΔTh2, the process proceeds to a filter coefficient decision step (S146).

As the resizing/rounding processing step (S142), the resizing/rounding processing unit 78 performs resizing processing and/or rounding processing on the development image.

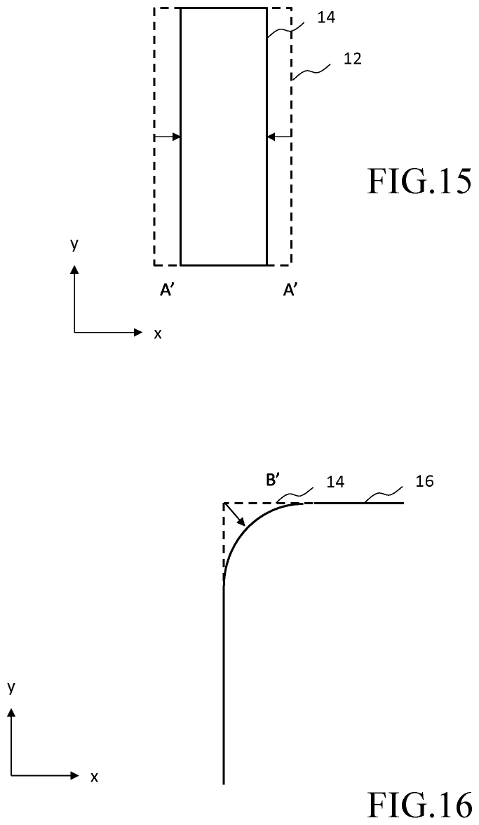

FIG. 15 is a diagram illustrating an example of figures before and after resizing in the first embodiment. The example of FIG. 15 illustrates a FIG. 14 obtained by resizing a width size of a FIG. 12 in the development image by a resizing amount A′. The resizing amount is set in advance. For example, resizing is performed by 0.5 pixels within a range of −5 pixels to +5 pixels. A negative value indicates resizing in a direction in which the width size decreases. A positive value indicates resizing in a direction in which the width size increases. Further, for example, 0.5 pixels indicates a resizing amount of ½ of the pixel size. The example of FIG. 15 illustrates a case where the FIG. 12 is resized in a direction of decreasing the width size. In the example of FIG. 15, the width size in the x direction is resized, but the width size in the y direction may be resized instead of the width size in the x direction. Alternatively, both the width size in the x direction and the width size in the y direction may be resized.

FIG. 16 is a diagram illustrating an example of figures before and after rounding processing in the first embodiment. In the example of FIG. 16, a FIG. 16 is illustrated in which a corner portion of a resized FIG. 14 is rounded by a rounding amount B′. As the rounding amount, when a range of the rounding amount is, for example, 0 to +2 pixels, rounding is performed by, for example, 0.2 pixels. For example, 0.2 pixels indicates a rounding amount of ⅕ of the pixel size. The rounding amount indicates the radius of curvature. In the example of FIG. 16, an upper left corner is illustrated, but other corners are similarly rounded.

After the resizing/rounding processing step (S142), the process returns to the filter function calculation step (S130), and the respective steps of the filter function calculation step (S130) to the resizing/rounding processing step (S142) are repeated until the maximum gradation difference Δmax becomes equal to or less than the threshold ΔTh2 in the determination step (S140). In other words, a suitable value of the filter function is learned.

As the filter coefficient decision step (S146), the decision unit 84 decides a true filter function for creating a reference image among the plurality of generated filter function candidates. For example, the decision unit 84 decides the filter function used to create the candidate for the reference image in which the maximum gradation difference Δmax is equal to or less than the threshold ΔTh2 as a true filter function. The decided filter function (coefficient matrix) is set in the reference circuit 112. Similarly, the resizing amount and the rounding amount at that time are set in the reference circuit 112. Then, the inspection processing of the entire target object 101 is started.

Here, in the above-described example, the case has been described in which it is first determined whether or not the contrasts between brightness and darkness of the patterns are reversed, and the filter function is calculated after the result is obtained, but the present disclosure is not limited thereto. For example, it is also preferable to determine whether or not the contrasts between brightness and darkness of the patterns are reversed using the frame image and the development image of the representative frame selected in the representative frame selection step (S131) in the filter function calculation step (S130). In such a case, a series of steps including the representative frame selection step (S102), the stripe image acquisition step (S104), the representative frame image creation step (S106), and the representative development image creation step (S110) and a series of steps including the representative frame selection step (S131), the stripe image acquisition step (S132), the representative frame image creation step (S134), and the representative development image creation step (S135) in the filter function calculation step (S130) can be commonalized. In the case of commonality, the representative frame selection step (S102), the stripe image acquisition step (S104), the representative frame image creation step (S106), and the representative development image creation step (S110) can be omitted. Alternatively, the representative frame selection step (S131), the stripe image acquisition step (S132), the representative frame image creation step (S134), and the representative development image creation step (S135) can be omitted. Then, a series of steps including the development image parameter calculation step (S112), the measurement image parameter calculation step (S114), and the determination step (S120) and the remaining steps of the filter function calculation step (S130) can be performed in parallel.

In a case where the operation is performed in parallel, when it is determined that the contrasts between brightness and darkness of the patterns are reversed in the determination step (S120), the filter function calculation circuit 140 stops the filter function calculation processing as an error in the filter function calculation step (S130) that is already in operation.

In this way, the filter function in a state in which the contrasts between brightness and darkness of the patterns of the measurement image and the development image are not reversed is calculated. Thereafter, the inspection processing of the target object 101 is started. The contents of the inspection processing will be described below.

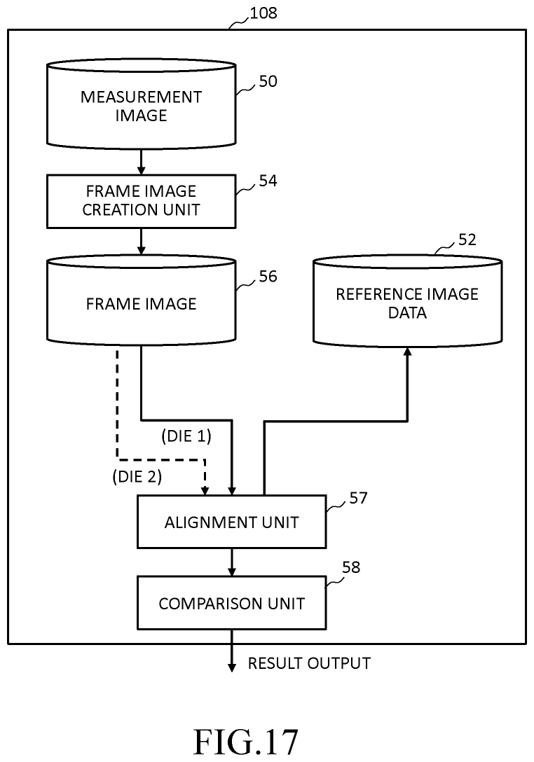

FIG. 17 is a diagram illustrating an example of an internal configuration of a comparison circuit in the first embodiment. In FIG. 17, storage devices 50, 52, and 56 such as magnetic disk drives, a frame image creation unit 54, an alignment unit 57, and a comparison unit 58 are arranged in the comparison circuit 108. A series of “units” such as the frame image creation unit 54, the alignment unit 57, and the comparison unit 58 includes a processing circuit. The processing circuit includes an electric circuit, a computer, a processor, a circuit board, a quantum circuit, or a semiconductor device. Further, a common processing circuit (same processing circuit) may be used for each “unit”. Alternatively, a different processing circuit (separate processing circuit) may be used. Input data necessary for the frame image creation unit 54, the alignment unit 57, and the comparison unit 58 or a calculated result is stored in a memory (not illustrated) in the comparison circuit 108 or the memory 115 each time.

As the stripe image acquisition step (S202) (also referred to as a scanning step or an optical image acquisition step), the optical image acquisition mechanism 150 acquires an optical image of the target object 101 to be inspected on which a pattern is formed. A method for acquiring the stripe image is similar to the above-described content. However, here, the stripe images are sequentially acquired as illustrated in FIG. 2. Then, pixel data is stored in the stripe pattern memory 123 for each inspection stripe 20. Thereafter, the stripe region image is sent to the comparison circuit 108 together with the data indicating the position of the target object 101 on the XYθ table 102 output from the position circuit 107. The measurement data (pixel data) is, for example, 8-bit unsigned data, and expresses the gradation (light amount) of the brightness of each pixel. The stripe region image output into the comparison circuit 108 is stored in the storage device 50.

As the frame image creation step (S204), in the comparison circuit 108, the frame image creation unit 54 generates a plurality of frame images 31 obtained by dividing the stripe region image (optical image) by a predetermined width. Specifically, as illustrated in FIG. 2, the stripe region image is divided into frame images of a plurality of rectangular frame regions 30. For example, the image is divided into a size of 512×512 pixels. The data of each frame region 30 is stored in the storage device 56.

As the development image creation step (S212), the development circuit 111 (development image creation unit) creates a development image that is developed using design pattern data that is a source of a pattern to be formed in a frame image (optical image). In other words, the development circuit 111 develops an image based on the design pattern data that is a basis of pattern formation of the target object 101 to be inspected, and creates a development image. Specifically, the development circuit 111 reads design data from the magnetic disk drive 109 through the control computer 110, and converts each figure of each frame region 30 defined in the read design data into binary or multi-valued image data. Then, a development image of 8-bit occupancy rate data is created for each pixel. The data (image data) of the development image is output to the reference circuit 112.

As the reference image creation step (S214), the reference circuit 112 (reference image creation unit) creates a reference image obtained by filtering the development image. Specifically, the reference circuit 112 resizes and rounds the development image with the set resizing amount and rounding amount, and then performs filter processing using the set coefficient matrix a(i, j) (an example of a filter function) to create a reference image. The created reference image is output to the comparison circuit 108, and the reference image output to the comparison circuit 108 is stored in the storage device 52.

Note that the set coefficient matrix a(i, j) (an example of a filter function) is used for the filter processing of all the development images in which the frame regions 30 in the inspection region 10 are different from each other.

As the comparison step (S230), the comparison circuit 108 (an example of a comparison unit) compares the frame image (optical image) with the reference image based on the development image in which the contrast between brightness and darkness of the pattern is not reversed relative to the frame image. Specifically, the following operation is performed. First, the alignment unit 57 reads a frame image (optical image) to be compared from the storage device 56, and similarly reads a reference image to be compared from the storage device 52. Then, alignment is performed by a predetermined algorithm. For example, the alignment is performed using a least squares method. The comparison unit 58 compares both the images for each pixel according to a predetermined determination condition and determines the presence or absence of a defect such as a shape defect, for example. As the determination condition, for example, both the images are compared for each pixel according to a predetermined algorithm to determine the presence or absence of a defect. In addition, a comparison result is output. The comparison result may be output to, for example, the magnetic disk drive 109, the flexible disk device (FD) 116, the CRT 117, and the pattern monitor 118, or may be output from the printer 119.

Here, in the above-described example, the configuration of determining whether or not the contrasts between brightness and darkness of the patterns are reversed between the frame image and the development image before the filter processing has been described. However, the present disclosure is not limited thereto. It may be determined whether or not the contrasts between brightness and darkness of the patterns are reversed between the frame image and the reference image after the filter processing.

In such a case, for example, it is determined whether or not the contrasts between brightness and darkness of the patterns are reversed using the frame image 31 of the representative frame selected by the frame selection unit 60 and the reference image. Alternatively, in the comparison step (S230), for example, it is also preferable to determine whether or not the contrasts between brightness and darkness of the patterns are reversed using the frame image 31 and the reference image to be compared first. In such a case, the frame image creation unit 62 calculates parameters of the target frame image. For example, an average gradation value is calculated. Similarly, the development image parameter calculation unit 64 (here, the reference image parameter calculation unit) calculates parameters of the target reference image. For example, an average gradation value is calculated. Then, the determination unit 68 uses the gradation values of the frame image (optical image) and the reference image to determine whether or not the contrasts between brightness and darkness of the pattern in the frame image (optical image) and the pattern in the reference image are matched.

As a result of the determination, when the contrasts between brightness and darkness of the patterns are reversed between the frame image (optical image) of the target frame region 30 and the reference image, the inspection processing is stopped. When the contrasts between brightness and darkness of the patterns are not reversed between the frame image (optical image) of the target frame region 30 and the reference image, the comparison circuit 108 compares the frame image (optical image) with the reference image in which the contrast between brightness and darkness of the pattern is not reversed relative to the frame image.

As described above, according to the first embodiment, it is possible to determine whether or not the contrasts between brightness and darkness of the patterns are reversed between the design data and the target object 101. Therefore, the inspection error can be suppressed or reduced. In particular, by determining that the contrast between brightness and darkness of the pattern is reversed before or during the calculation of the filter function, it is possible to stop or suspend the inspection as an inspection error before the start of the actual scanning of the target object 101 and before the creation of the development image/reference image. In addition, even in the case of the contrast determination of the pattern after the start of the inspection processing, it is possible to stop or suspend the inspection as an inspection error at an early stage by determining that the contrast between brightness and darkness of the pattern is reversed at an early stage.

### Second Embodiment

In the first embodiment, a configuration in which the inspection is stopped or suspended as an inspection error when contrasts between brightness and darkness of a pattern in an optical image and a pattern in a development image are reversed in a determination step (S120) has been described, but the present disclosure is not limited thereto. In a second embodiment, a configuration including the determination of a user will be described. A configuration of an inspection apparatus 100 is similar to that of FIG. 1. Contents other than points specifically described below are similar to those in the first embodiment.

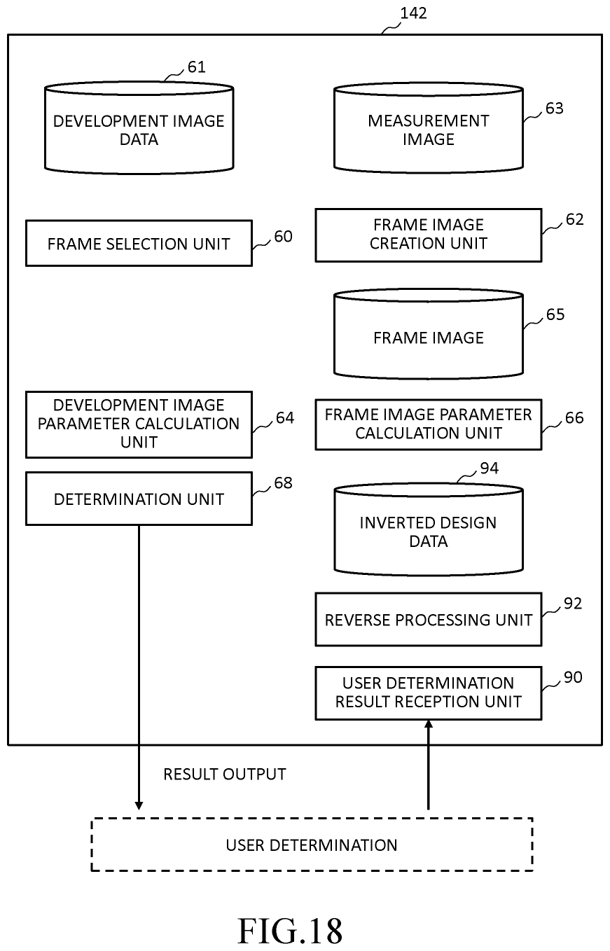

FIG. 18 is a block diagram illustrating an example of an internal configuration of a contrast determination processing circuit in the second embodiment. FIG. 18 is similar to FIG. 4 except that a user determination result reception unit 90, a reverse processing unit 92, and a storage device 94 such as a magnetic disk are further arranged in a contrast determination processing circuit 142.

A series of “units” such as a frame selection unit 60, a frame image creation unit 62, a development image parameter calculation unit 64, a frame image parameter calculation unit 66, a determination unit 68, a user determination result reception unit 90, and a reverse processing unit 92 includes a processing circuit. The processing circuit includes an electric circuit, a computer, a processor, a circuit board, a quantum circuit, or a semiconductor device. Further, a common processing circuit (same processing circuit) may be used for each “unit”. Alternatively, a different processing circuit (separate processing circuit) may be used. Input data necessary for the frame selection unit 60, the frame image creation unit 62, the development image parameter calculation unit 64, the frame image parameter calculation unit 66, the determination unit 68, the user determination result reception unit 90, and the reverse processing unit 92 or a calculated result is stored in a memory (not illustrated) in the contrast determination processing circuit 142 or a memory 115 each time.

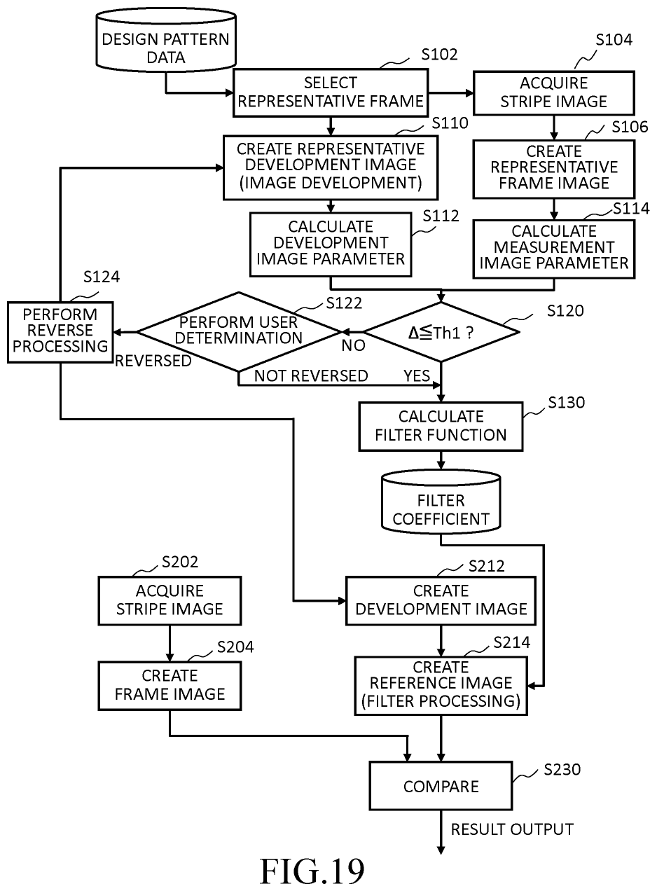

FIG. 19 is a flowchart illustrating main steps of a pattern inspection method in the second embodiment. FIG. 19 is similar to FIG. 5 except that a user determination step (S122) and a reverse processing step (S124) are added between a determination step (S120) and a filter function calculation step (S130).

The contents of the respective steps of the representative frame selection step (S102), the stripe image acquisition step (S104), the representative frame image creation step (S106), the representative development image creation step (S110), the development image parameter calculation step (S112), the measurement image parameter calculation step (S114), and the determination step (S120) are similar to those in the first embodiment. However, in the determination step (S120), in a case where the contrasts between brightness and darkness of the pattern in the image and the pattern in the development image are reversed, the process proceeds to the user determination step (S122). In other words, as a result of the determination, in a case where it is determined that the contrasts between brightness and darkness are reversed, the result is output to the user.

In addition, it is preferable that a plurality of representative frames are selected in the representative frame selection step (S102). In such a case, it is preferable to output the result to the user in a case where it is determined in the determination step (S120) that the contrast between brightness and darkness of at least one representative frame among the plurality of representative frames is reversed.

As the user determination step (S122), the user uses a pattern monitor 118 to confirm whether or not the contrasts between brightness and darkness of the pattern in the optical image and the pattern in the development image are reversed. Then, the user determines whether or not to perform processing of reversing a contrast between brightness and darkness of a pattern of design data. Then, the user determination result reception unit 90 receives a user determination result from the user. In a case where information indicating that the processing of reversing the contrast between brightness and darkness of the pattern is not performed is received from the user, it is determined that the contrasts between brightness and darkness of the pattern in the optical image and the pattern in the development image are not reversed, and the process proceeds to the filter function calculation step (S130). In other words, in a case where the user determination result reception unit 90 receives, from the user, information indicating that the processing of reversing the contrast between brightness and darkness of the pattern is not performed, the comparison circuit 108 uses the development image used for the determination by the determination unit 68 as the development image in which the contrast between brightness and darkness is not reversed.

In a case where the user determination result reception unit 90 receives, from the user, information indicating that the processing of reversing the contrast between brightness and darkness of the pattern is performed, the process proceeds to the reverse processing step (S124).

As the reverse processing step (S124), in a case of receiving the information indicating that the processing of reversing the contrast between brightness and darkness of the pattern is performed from the user, the reverse processing unit 92 performs processing of reversing the contrast between brightness and darkness of the pattern of the design data that is a source of the development image. The inverted design data in which the contrast between brightness and darkness of the pattern has been reversed is stored in the storage device 94. Then, the processing returns to the representative development image creation step (S110), and the representative development image creation step (S110), the development image parameter calculation step (S112), the measurement image parameter calculation step (S114), and the determination step (S120) are performed again. In the measurement image parameter calculation step (S114), the previous result may be suitably used.

The contents of each step after the filter function calculation step (S130) are similar to those in the first embodiment.

Here, in the above-described example, the case has been described in which it is first determined whether or not the contrasts between brightness and darkness of the patterns are reversed, and the filter function is calculated after the result is obtained, but the present disclosure is not limited thereto. For example, it is also preferable to determine whether or not the contrasts between brightness and darkness of the patterns are reversed using the frame image and the development image of the representative frame selected in the representative frame selection step (S131) in the filter function calculation step (S130). In such a case, a series of steps including the representative frame selection step (S102), the stripe image acquisition step (S104), the representative frame image creation step (S106), and the representative development image creation step (S110) and a series of steps including the representative frame selection step (S131), the stripe image acquisition step (S132), the representative frame image creation step (S134), and the representative development image creation step (S135) in the filter function calculation step (S130) can be commonalized. In the case of commonality, the representative frame selection step (S102), the stripe image acquisition step (S104), the representative frame image creation step (S106), and the representative development image creation step (S110) can be omitted. Alternatively, the representative frame selection step (S131), the stripe image acquisition step (S132), the representative frame image creation step (S134), and the representative development image creation step (S135) can be omitted. Then, a series of steps including the development image parameter calculation step (S112), the measurement image parameter calculation step (S114), the determination step (S120), the user determination step (S122), and the reverse processing step (S124) and the remaining steps of the filter function calculation step (S130) can be performed in parallel.

In a case where the operation is performed in parallel, when it is determined in the determination step (S120) that the contrasts between brightness and darkness of the patterns are reversed, the process proceeds to the user determination step (S122). Then, in a case where the reverse processing of the pattern is performed, the process proceeds to the reverse processing step (S124), and after the reverse processing, the process returns to the representative development image creation step (S135) (or the representative development image creation step (S110)), and the subsequent steps are performed again. In a case where the reverse processing of the pattern is not performed, each step of the filter function calculation step (S130) may be continued.

Further, in the above-described example, the configuration of determining whether or not the contrasts between brightness and darkness of the patterns are reversed between the frame image and the development image before the filter processing has been described. However, the present disclosure is not limited thereto. Similarly to the first embodiment, it may be determined whether or not the contrasts between brightness and darkness of the patterns are reversed between the frame image and the reference image after the filter processing.

In such a case, for example, it is determined whether or not the contrasts between brightness and darkness of the patterns are reversed using the frame image 31 of the representative frame selected by the frame selection unit 60 and the reference image. Alternatively, in the comparison step (S230), for example, it is also preferable to determine whether or not the contrasts between brightness and darkness of the patterns are reversed using the frame image 31 and the reference image to be compared first. In such a case, the frame image creation unit 62 calculates parameters of the target frame image. For example, an average gradation value is calculated. Similarly, the development image parameter calculation unit 64 (here, the reference image parameter calculation unit) calculates parameters of the target reference image. For example, an average gradation value is calculated. Then, the determination unit 68 uses the gradation values of the frame image (optical image) and the reference image to determine whether or not the contrasts between brightness and darkness of the pattern in the frame image (optical image) and the pattern in the reference image are matched.

As a result of the determination, when the contrasts between brightness and darkness of the patterns are reversed between the frame image (optical image) of the target frame region 30 and the reference image, the determination result is output to the user.

Then, the user uses the pattern monitor 118 to confirm whether or not the contrasts between brightness and darkness of the pattern in the optical image and the pattern in the reference image are reversed. Then, the user determines whether or not to perform processing of reversing a contrast between brightness and darkness of a pattern of design data. Then, the user determination result reception unit 90 receives a user determination result from the user. In a case where the information indicating that the processing of reversing the contrast between brightness and darkness of the pattern is not performed is received from the user, it is determined that the contrasts between brightness and darkness of the pattern in the optical image and the pattern in the reference image are not reversed, and the process proceeds to the comparison step (S230). In other words, in a case where the user determination result reception unit 90 receives, from the user, information indicating that the processing of reversing the contrast between brightness and darkness of the pattern is not performed, the comparison circuit 108 uses the reference image used for the determination by the determination unit 68 as the reference image in which the contrast between brightness and darkness is not reversed.

Alternatively, in a case where the user determination result reception unit 90 receives the information indicating that the processing of reversing the contrast between brightness and darkness of the pattern is performed from the user, the reverse processing unit 92 performs processing of reversing the contrast between brightness and darkness of the pattern of the design data that is a source of the reference image. The inverted design data in which the contrast between brightness and darkness of the pattern has been reversed is stored in the storage device 94. Then, each step for obtaining the filter coefficient is performed again.

As described above, the comparison circuit 108 can compare the frame image (optical image) with the reference image in which the contrast between brightness and darkness of the pattern is not reversed.

The embodiments have been described with reference to the specific examples. However, the present disclosure is not limited to these specific examples. For example, in the embodiment, the transmitted illumination optical system using the transmitted light is illustrated as the illumination optical system 170, but the present disclosure is not limited thereto. For example, a reflected illumination optical system using reflected light may be used. Alternatively, the transmitted light and the reflected light may be simultaneously used by combining the transmitted illumination optical system and the reflected illumination optical system.

Note that the reverse processing step (S124) is also applied to the development image creation step (S212) in FIG. 19. Specifically, the reverse processing step (S124) is applied not only to the design data of the representative frame but also to all the design data.

In addition, the filter function and the coefficients of the filter function described above are examples, and the present disclosure is not limited thereto. Other filter functions and coefficients of the filter functions may be used.

Further, descriptions of parts and the like that are not directly necessary for explanation of the present disclosure, such as an apparatus configuration and a control method, have been omitted. However, the necessary apparatus configuration and control method can be appropriately selected and used. For example, although the description of the control unit configuration for controlling the inspection apparatus 100 is omitted, it goes without saying that the necessary control unit configuration is appropriately selected and used.

Further, all pattern inspection apparatuses and pattern inspection methods including the elements of the present disclosure and capable of being appropriately designed and changed by those skilled in the art are included in the scope of the present disclosure.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern inspection apparatus comprising:
an optical image acquisition mechanism configured to acquire an optical image of a target object to be inspected on which a pattern is formed;
a development image creation circuit configured to create a development image that is developed using design data that is a source of a pattern to be formed in the optical image;
a reference image creation circuit configured to create a reference image obtained by filtering the development image;
a determination circuit configured to, using gradation values of the optical image and one of the development image and the reference image, determine whether or not contrasts between brightness and darkness of a pattern in the optical image and a pattern in the one of the development image and the reference image are reversed;
a comparison circuit configured to compare the optical image with one of (i) a reference image in which a contrast between brightness and darkness is not reversed relative to the optical image and(ii) a reference image based on the development image in which a contrast between brightness and darkness is not reversed relative to the optical image, in a case where it is determined as a result of a determination that the contrasts between brightness and darkness are not reversed; and
a filter function calculation circuit configured to calculate a filter function for creating the reference image, wherein
the filter function calculation circuit does not perform or stops processing of the calculating as an error in a case where the contrasts between brightness and darkness are reversed as a result of determining whether or not the contrasts between brightness and darkness of the pattern in the optical image and the pattern in the development image are reversed by the determination circuit.

2. The pattern inspection apparatus according to claim 1, wherein the determination circuit compares an average gradation value of an entire image of the optical image with an average gradation value of an entire image of the one of the development image and the reference image to determine whether or not the contrasts between brightness and darkness are reversed.

3. The pattern inspection apparatus according to claim 1, wherein the determination circuit determines whether or not the contrasts between brightness and darkness are reversed for each pixel.

4. The pattern inspection apparatus according to claim 1, wherein the determination circuit determines whether or not the contrasts between brightness and darkness are reversed by comparing, for each pixel, whether or not signs of gradients of gradation values are matched between a target pixel and an adjacent pixel adjacent to the target pixel.

5. A pattern inspection apparatus comprising:
an optical image acquisition mechanism configured to acquire an optical image of a target object to be inspected on which a pattern is formed;
a development image creation circuit configured to create a development image that is developed using design data that is a source of a pattern to be formed in the optical image;
a reference image creation circuit configured to create a reference image obtained by filtering the development image;
a determination circuit configured to, using gradation values of the optical image and one of the development image and the reference image, determine whether or not contrasts between brightness and darkness of a pattern in the optical image and a pattern in the one of the development image and the reference image are reversed;
a comparison circuit configured to compare the optical image with one of (i) a reference image in which a contrast between brightness and darkness is not reversed relative to the optical image and(ii) a reference image based on the development image in which a contrast between brightness and darkness is not reversed relative to the optical image, in a case where it is determined that the contrasts between brightness and darkness are not reversed; and
a reception circuit configured to receive, from a user, information indicating whether or not to perform processing of reversing a contrast between brightness and darkness of a pattern, wherein
the determination circuit outputs a result to the user in a case where it is determined that the contrasts between brightness and darkness are reversed, and
in a case where the reception circuit receives information indicating that the processing of reversing the contrast between brightness and darkness of the pattern is not performed from the user, the one of the development image and the reference image used for the determination by the determination circuit is used as the one of the development image in which the contrast between brightness and darkness is not reversed and the reference image in which the contrast between brightness and darkness is not reversed.

6. The pattern inspection apparatus according to claim 5, further comprising: a reverse processing circuit configured to perform processing of reversing a contrast between brightness and darkness of a pattern of design data that is a source of the development image or the reference image, in a case where the reception circuit receives information indicating that the processing of reversing the contrast of the pattern is performed from the user.

7. A pattern inspection method comprising:
acquiring an optical image of a target object to be inspected on which a pattern is formed;
creating a development image that is developed using design data that is a source of a pattern to be formed in the optical image;
creating a reference image obtained by filtering the development image;
determining, using gradation values of the optical image and one of the development image and the reference image, whether or not contrasts between brightness and darkness of a pattern in the optical image and a pattern in the one of the development image and the reference image are reversed;
comparing the optical image with one of (i) a reference image in which a contrast between brightness and darkness is not reversed relative to the optical image and (ii) a reference image based on the development image in which a contrast between brightness and darkness is not reversed relative to the optical image and outputting a comparison result, in a case where it is determined that the contrasts between brightness and darkness are not reversed; and
calculating a filter function for creating the reference image, in the case where it is determined as the result of the determining that the contrasts between brightness and darkness are not reversed, wherein
processing of the calculating does not perform or stops as an error in a case where the contrasts between brightness and darkness are reversed as a result of the determining whether or not the contrasts between brightness and darkness of the pattern in the optical image and the pattern in the development image are reversed.

8. A pattern inspection method comprising:
acquiring an optical image of a target object to be inspected on which a pattern is formed;
creating a development image that is developed using design data that is a source of a pattern to be formed in the optical image;
creating a reference image obtained by filtering the development image;
determining, using gradation values of the optical image and one of the development image and the reference image, whether or not contrasts between brightness and darkness of a pattern in the optical image and a pattern in the one of the development image and the reference image are reversed;
comparing the optical image with one of (i) a reference image in which a contrast between brightness and darkness is not reversed relative to the optical image and (ii) a reference image based on the development image in which a contrast between brightness and darkness is not reversed relative to the optical image and outputting a comparison result, in a case where it is determined that the contrasts between brightness and darkness are not reversed;
outputting a result to a user, in a case where it is determined that the contrasts between brightness and darkness are reversed; and
receiving, from the user, information indicating whether or not to perform processing of reversing a contrast between brightness and darkness of a pattern, wherein
in a case where information indicating that the processing of reversing the contrast between brightness and darkness of the pattern is not performed is received from the user, the one of the development image and the reference image used for the determining is used as the one of the development image in which the contrast between brightness and darkness is not reversed and the reference image in which the contrast between brightness and darkness is not reversed.

9. The pattern inspection apparatus according to claim 5, wherein the determination circuit compares an average gradation value of an entire image of the optical image with an average gradation value of an entire image of the one of the development image and the reference image to determine whether or not the contrasts between brightness and darkness are reversed.

10. The pattern inspection apparatus according to claim 5, wherein the determination circuit determines whether or not the contrasts between brightness and darkness are reversed for each pixel.

11. The pattern inspection apparatus according to claim 5, wherein the determination circuit determines whether or not the contrasts between brightness and darkness are reversed by comparing, for each pixel, whether or not signs of gradients of gradation values are matched between a target pixel and an adjacent pixel adjacent to the target pixel.

12. The pattern inspection method according to claim 7, wherein it is determined whether or not the contrasts between brightness and darkness are reversed by comparing an average gradation value of the entire image of the optical image with an average gradation value of an entire image of the one of the development image and the reference image.

13. The pattern inspection method according to claim 7, wherein it is determined whether or not the contrasts between brightness and darkness are reversed for each pixel.

14. The pattern inspection method according to claim 7, wherein it is determined whether or not the contrasts between brightness and darkness are reversed by comparing, for each pixel, whether or not signs of gradients of gradation values are matched between a target pixel and an adjacent pixel adjacent to the target pixel.

15. The pattern inspection method according to claim 8, wherein it is determined whether or not the contrasts between brightness and darkness are reversed by comparing an average gradation value of an entire image of the optical image with an average gradation value of an entire image of the one of the development image and the reference image.

16. The pattern inspection method according to claim 8, wherein it is determined whether or not the contrasts between brightness and darkness are reversed for each pixel.

17. The pattern inspection method according to claim 8, wherein it is determined whether or not the contrasts between brightness and darkness are reversed by comparing, for each pixel, whether or not signs of gradients of gradation values are matched between a target pixel and an adjacent pixel adjacent to the target pixel.

18. The pattern inspection method according to claim 8, further comprising: performing processing of reversing a contrast between brightness and darkness of a pattern of design data that is a source of the one of the development image and the reference image, in a case of receiving information indicating that the processing of reversing the contrast between brightness and darkness of the pattern is performed from the user.
